(19) United States
(12) Patent Application Publication
(10) Pub. No.: US 2015/0311723 A1
(43) Pub. Date: Oct. 29, 2015

(54) PARALLEL SERIES DC INDUCTIVE POWER TRANSFER SYSTEM

(71) Applicant: Evatran Group, Inc., Wytheville, VA (US)

(72) Inventors: Steven Monroe Raedy, Raleigh, NC (US); Thomas Gattan Stout, II, Morrisville, NC (US); Robert Joseph Callanan, Raleigh, NC (US)

(21) Appl. No.: 14/674,449

(22) Filed: Mar. 31, 2015

Related U.S. Application Data
(60) Provisional application No. 61/972,728, filed on Mar. 31, 2014.

(51) Int. Cl. H02J 5/00; H02J 7/02; B60L 11/18; H02J 17/00

(52) U.S. Cl. CPC H02J 5/005; H02J 17/00; H02J 7/025; B60L 11/182

(57) ABSTRACT

An inductive power transfer system for a device such as battery charger on an electric vehicle includes a primary circuit having a rectifier and an H bridge inverter connected in parallel with a reactor connected in series to deliver direct current voltage to a stationary primary coil of a transformer. The system further includes a secondary circuit on the vehicle including a secondary coil and another rectifier connected in series. AC voltage from a power supply is converted to DC voltage and then transformed into a pulse width modulated high frequency square wave voltage for electromagnetic transfer from the primary coil to the secondary coil. The square wave voltage is converted back to DC voltage for delivery to a vehicle charger.

This application claims the benefit of U.S. provisional patent application No. 61/972,728 filed Mar. 31, 2014.

### BACKGROUND OF THE INVENTION

Electric vehicles include batteries which must be charged regularly, typically every day. For many consumers, remembering to plug the vehicle into a battery charging system at the end of the day is a major inconvenience. For others, there is apprehension in handling a 240V AC (alternating current) power supply, particularly in wet conditions. Inductive charging overcomes many of the issues of prior plug-in charging systems because there is no need to physically handle the plug every day to charge the vehicle batteries. Inductive charging provides hands-free automatic charging when the vehicle is parked adjacent to a charging pad.

### SUMMARY OF THE INVENTION

The subject inductive power transfer system generates direct current (DC) voltage used to power a device such as a battery charger on an electric vehicle to charge the vehicle batteries. The system includes a transformer including a stationary primary coil and a secondary coil mounted on the vehicle. When the vehicle is parked adjacent to the primary coil, inductive charging occurs. A primary circuit is connected between an AC power supply and the stationary primary coil. The primary circuit includes a rectifier which converts AC voltage to DC voltage and a bridge inverter that creates a pulse width modulated square wave voltage to drive the primary coil. The rectifier and inverter are connected in parallel with the primary coil. In an alternate embodiment, a power factor correction (PFC) circuit can be provided in the primary circuit at the output of the rectifier to provide the DC voltage.

According to a preferred embodiment, a reactor is connected in series between the output of the bridge inverter and the primary coil. In addition, the bridge inverter is an H bridge formed of transistors. A link capacitor is also connected in parallel between the rectifier and the H bridge to filter the rectified DC voltage.

The secondary circuit includes a secondary coil inductively coupled with the primary coil to receive the square wave voltage from the primary circuit. A rectifier is connected in series with the secondary coil to convert the AC voltage to a DC voltage which is used by the battery charger to charge the vehicle batteries. The secondary circuit also includes a link capacitor connected in series with the secondary circuit rectifier.

### BRIEF DESCRIPTION OF THE FIGURES

Other objects and advantages of the invention will become apparent from a study of the following specification when viewed in the light of the accompanying drawing, in which:

FIG. 1 is a circuit diagram of the inductive power transfer system according to the invention;

FIG. 2 is a graph of the AC voltage delivered to the input of the system;

FIG. 3 is a graph of the primary circuit rectifier output;

FIGS. 4 and 5 are graphical representations of the primary circuit input voltage and high frequency AC output from the primary coil, respectively;

FIGS. 6 and 7 are graphical representations of the high frequency AC output from the secondary coil and DC output voltage to the vehicle charger, respectively; and

FIG. 8 is a circuit diagram of an alternate embodiment of the inductive power transfer system according to the invention.

### DETAILED DESCRIPTION

FIG. 1 illustrates the subject parallel series inductive charging system. The system includes circuitry arranged in three components: a control panel 2, a stationary parking pad 4, and a vehicle adapter 6. The control panel is typically mounted on the wall of a vehicle owner's garage. It is connected with the parking pad which is mounted on the floor of the garage in the region where an electric vehicle is routinely parked. The vehicle adapter is mounted on the electric vehicle. When the vehicle is not in use and parked in the garage above the parking pad, the inductive charging system charges a battery charger in the vehicle which in turn charges the batteries used in the vehicle to power the engine. Inductive charging is accomplished via a transformer 8 by way of an energy transfer between a stationary primary coil 10 arranged within the parking pad 4 and a secondary coil 12 mounted within the vehicle adapter 6.

The control panel 2 is connected with an AC voltage source 14. The control panel includes a primary circuit which is connected with the stationary primary coil. More particularly, the primary circuit includes a rectifier 16 connected with the AC voltage source and an inverter 18 connected in parallel with the rectifier. The rectifier is formed from a capacitor bank or a plurality of diodes 20 connected in a known manner. The inverter includes a bridge of transistors 22 such as metal oxide semiconductor field effect transistors (MOSFETs) or insulated gate bipolar transistors (IGBTs). The transistors are preferably connected to form an H bridge inverter as shown. A large link capacitor 24 is connected in parallel with and between the rectifier and the inverter.

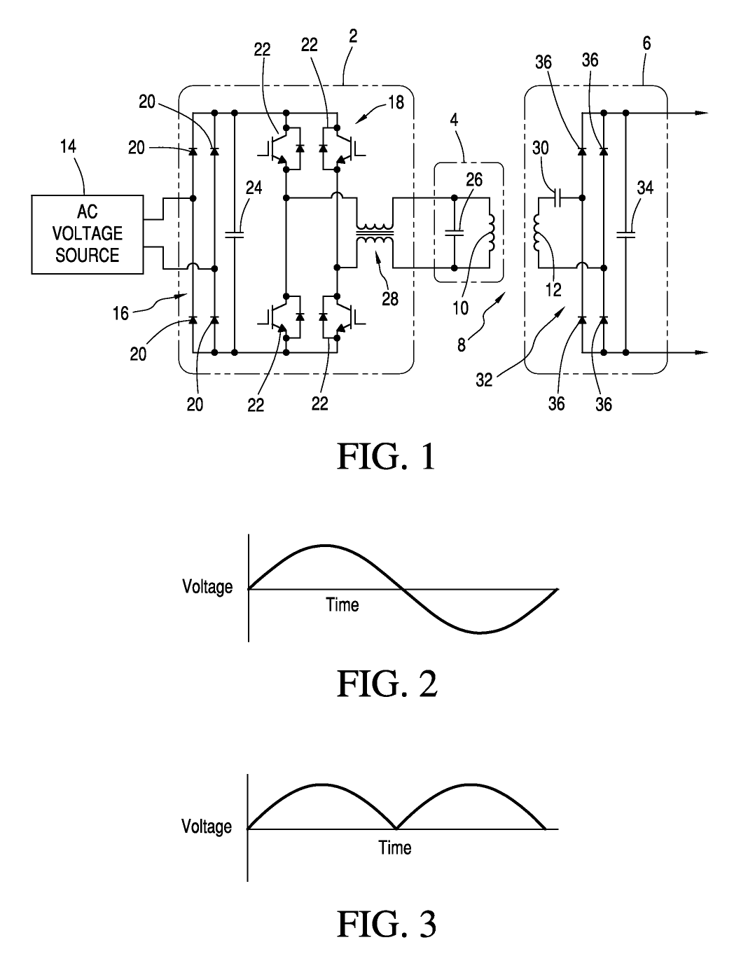

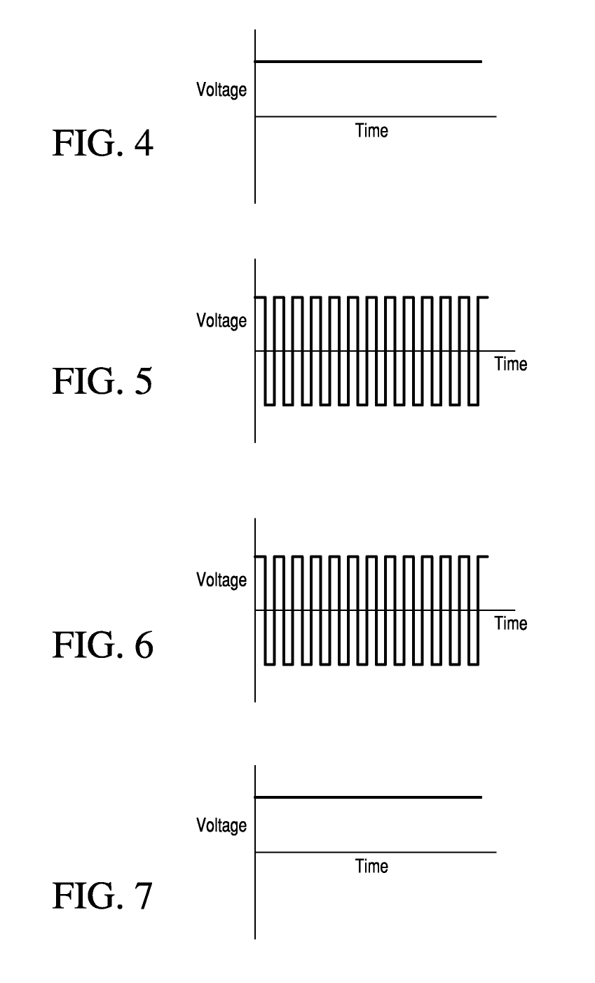

FIG. 2 shows the voltage waveform at the output of the AC voltage source 14 which is the input to the primary circuit in the control panel. The rectifier 16 of the primary circuit converts the AC voltage to DC resulting in the waveform shown in FIG. 3 which is from the output of the rectifier. The link capacitor 24 filters the rectifier output resulting in the waveform shown in FIG. 4. The DC output from the link capacitor is delivered to the inverter which creates a pulse width modulated high frequency square wave voltage (FIG. 5) to drive the primary coil 10 of the parking pad. A further capacitor 26 is connected in parallel with the primary coil.

A reactor 28 in the form of an inductor is connected in series with the output of the inverter. The reactor limits the current output of the inverter so that the capacitor 24 is not a short circuit on the output of the inverter. The reactance of the reactor comprises an imaginary part of the coupling impedance, i.e. the impedance at the output of the inverter. This can be referred to as the reactive or imaginary part of the equivalent series impedance. By selecting the inductance of the reactor, the insertion reactance of the system can be controlled.

In one embodiment, the inductance of the reactor is chosen to be equal to the inductance of the stationary primary coil 10. The insertion reactance is then minimized at the resonant frequency of the system, i.e. the primary 10 and secondary 12 coils of the system transformer. This is true independent of the coupling coefficient between the primary and secondary coils, defined as

k=LM/√(Lp*Ls)

where LM is the mutual inductance;
Lp is primary inductance; and
Ls is secondary inductance.

The benefit of minimizing the reactive impedance is that the output voltage of the secondary is independent of the load applied. This creates a stiff source of voltage to the vehicle charger. Stiff voltage is defined as a voltage which is only dependent on the input voltage and the coupling ratio, and independent of the load value.

Accordingly,

Vout=Vin*k

where Vout is the output voltage to the vehicle charger; and
Vin is the voltage output from the inverter.

This equation is valid where the primary and secondary coils have substantially the same inductance. If the coils are not substantially the same inductance, then

Vout=Vin*k*C

where C is a constant which is dependent on the self-inductance values of the primary and secondary coils.
C also depends on the construction details of the coils. C is independent of load.

Under these conditions, the vehicle coil 12 can be significantly misaligned relative to the stationary primary coil 10 (wide variation of the value of k), while the output voltage to the vehicle charger remains stable with respect to changes of the output load and the system is driven at a fixed frequency.

In another embodiment, the inductance of the reactor is chosen to be different from, i.e. above or below, the inductance of the primary coil. The insertion reactance is then minimized at a frequency which is dependent on the value of k. The stiff voltage output will be at a frequency which may be the resonant frequency of the system or another drive frequency.

The reactor balances the differential mode currents in the charging system to reduce radiated emissions and losses in the system. In a preferred embodiment, the reactor comprises a dual winding over a gapped iron core to balance common and differential mode currents on both sides of the charging system and to control the electromagnetic field for controlling radiated emissions. In alternate embodiments, air, ferrite, amorphous material, or nano-crystalline cores may be used for the reactor, with single or dual windings.

A secondary circuit is arranged within the vehicle adapter 6 and includes a capacitor 30 and rectifier 32 connected in series with the secondary winding 12 and a link capacitor 34 connected in parallel with the rectifier. Like the rectifier in the primary circuit, the secondary circuit rectifier may be formed from a capacitor bank or a plurality of diodes 36. The secondary circuit rectifier converts the high frequency AC output from the secondary coil 12 to a DC output which is delivered to the vehicle charger. The high frequency AC output from the coil 12 is shown in FIG. 6 and the DC output from the secondary circuit rectifier 32 is shown in FIG. 7. As these figures show, the high frequency AC output from the secondary coil matches the pulse width modulated high frequency square wave voltage from the inverter 18 of the primary circuit and the DC output from the secondary circuit rectifier matches the filtered primary circuit rectifier output.

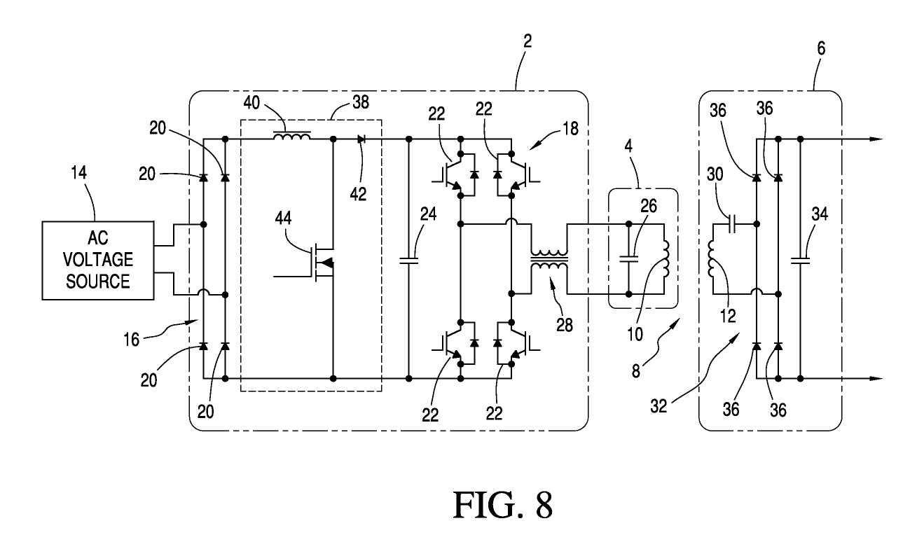

In an alternate embodiment shown in FIG. 8, the primary circuit within the control panel 2 includes a power factor correction (PFC) circuit 38 connected in series between the rectifier 16 and the link capacitor 24. The power factor correction circuit includes an inductor 40 connected with a diode 42 and with a transistor 44. The circuit 38 provides DC voltage to the link capacitor.

In operation, AC power is provided to the control panel and is rectified by the rectifier 16 of the primary circuit. The link capacitor 24 filters the rectified AC into DC. The DC output from the filtering capacitor is delivered to an inverter that creates a pulse width modulated high frequency square wave voltage to drive the parking pad. The high frequency AC is magnetically coupled from the parking pad coil to the vehicle adapter coil where it is rectified back into DC by the secondary circuit rectifier 32 and fed to the battery charger on the vehicle. The reactor 28 at the output of the inverter provides load regulation of the system secondary output voltage. A dual wound reactor balances differential mode currents on both sides of the system. An iron core reactor controls the stray magnetic field to improve radiated emissions.

While the preferred forms and embodiments of the invention have been illustrated and described, it will be apparent to those of ordinary skill in the art that various changes and modifications may be made without deviating from the inventive concepts set forth above.

What is claimed is:

1. An inductive power transfer system, comprising (a) a transformer including a stationary primary coil and a receiving secondary coil mounted on a device to receive power;
(b) a primary circuit connected between an AC voltage source and said stationary primary coil, said primary circuit including a rectifier and a bridge inverter connected in parallel with said inductor primary coil; and
(c) a secondary circuit including a rectifier connected in series with said receiving secondary coil to produce a DC output.

2. An inductive power transfer system as defined in claim 1, wherein said bridge inverter comprises a plurality of transistors.

3. An inductive power transfer system as defined in claim 2, wherein bridge inverter comprises an H bridge.

4. An inductive power transfer system as defined in claim 3, wherein said H bridge comprises four transistors.

5. An inductive power transfer system as defined in claim 3, wherein said transistors comprise one of metal oxide semiconductor field effect transistors and insulated gate bipolar transistors.

6. An inductive power transfer system as defined in claim 1, and further comprising a reactor connected in series between an output of said bridge inverter and said stationary primary coil.

7. An inductive power transfer system as defined in claim 6, and further comprising a capacitor connected in parallel with said stationary primary coil and a capacitor connected in series with said receiving secondary coil.

8. An inductive power transfer system as defined in claim 6, wherein said reactor has an inductance equivalent to a self-inductance of said primary stationary coil.

9. An inductive power transfer system as defined in claim 6, wherein said reactor has an inductance which is above a self-inductance of said stationary primary coil.

10. An inductive power transfer system as defined in claim 6, wherein said reactor has an inductance which is below a self-inductance of said stationary primary coil.

11. An inductive power transfer system as defined in claim 6, wherein said reactor includes at least one of an iron, ferrite, amorphous material, nano-crystalline, and air core.

12. An inductive power transfer system as defined in claim 11, wherein said reactor comprises dual identical coils on the same core.

13. An inductive power transfer system as defined in claim 11, wherein said reactor comprises a pair of identical separate cores, each of said cores having a single winding.

14. An inductive power transfer system as defined in claim 6, wherein said primary circuit rectifier comprises a capacitor bank.

15. An inductive power transfer system as defined in claim 6, wherein said primary circuit rectifier comprises a plurality of diodes.

16. An inductive power transfer system as defined in claim 6, and further comprising a link capacitor connected in parallel between said primary circuit rectifier and said H bridge.

17. An inductive power transfer system as defined in claim 6, wherein said primary circuit further comprises a power factor correction circuit between said rectifier and said link capacitor.

18. An inductive power transfer system as defined in claim 6, wherein said secondary circuit rectifier comprises a capacitor bank.

19. An inductive power transfer system as defined in claim 6, wherein said secondary circuit rectifier comprises a plurality of diodes.

20. An inductive power transfer system as defined in claim 6, and further comprising a link capacitor connected in series with said secondary circuit rectifier.
